(19) United States
(12) Patent Application Publication
(10) Pub. No.: US 2025/0042666 A1
(43) Pub. Date: Feb. 6, 2025

(54) SAPLING TRAY HANDLING SYSTEM

(71) Applicant: Deere & Company, Moline, IL (US)

(72) Inventors: Vishal Puranik, Osmanabad (IN); Syed Gouse Moiddin, HYDERABAD (IN); Harshal Deore, SATANA (IN); Rahul Chopde, NAGPUR (IN); Ritesh Kondekar, PUNE (IN)

(21) Appl. No.: 18/600,912

(22) Filed: Mar. 11, 2024

(30) Foreign Application Priority Data
Aug. 2, 2023 (IN) 202321051847

(51) Int. Cl. B65G 35/08; A01C 11/00; A01C 11/02; B65G 1/02

(52) U.S. Cl. CPC B65G 35/08; A01C 11/006; A01C 11/025; B65G 1/023; B65G 2201/0202; B65G 2201/0258

(57) ABSTRACT

A sapling tray handling system for a transplanter comprising a track, a plurality of sapling trays, and a drive mechanism. The track is in the form of rectangular loop having four corners and four sides. The sapling trays are configured to traverse the track. The drive mechanism propels the plurality of sapling trays. Each corner of the rectangular track is configured to secure a sapling tray. The drive mechanism comprises four actuators with each actuator positioned at one of the four corners. Each actuator is configured to propel the sapling tray secured at the respective corner.

### CROSS-REFERENCE TO RELATED APPLICATIONS

This application claims priority under 35 U.S.C. § 119 to patent application IN 202321051847, filed on 2 Aug. 2023, the disclosure of which is incorporated herein by reference.

### FIELD OF THE DISCLOSURE

The present disclosure relates to silviculture and more specifically a sapling transplanter for forests.

### BACKGROUND OF THE DISCLOSURE

The silviculture process can be slow, cumbersome, and may require careful handling because the process involves planting fragile saplings into the ground. Furthermore, precision in planting depth, subsequent watering, fertilization, water retention around the sapling, and adequate spacing between saplings are some of many variables adding to the complexity to optimize the survival rates and growth of saplings once planted. Saplings can generally be sensitive to the environmental conditions, handling, and conditions of planting. Generally done by hand, therein lies a need for an automated or semi-automated process to efficiently and carefully plant a multitude of saplings into the ground to support reforestation efforts.

An automated or semi-automated planting process may aim to plant maximum number of saplings with high-speed and precision planting operation considering time duration, economy, cost factor, availability of manpower etc. As a part of high-speed and precision planting, a planter vehicle or transplanter needs to store a large volume of saplings which are brought from nursery to the planting field. The thousands of saplings typically come in multiple sapling trays. The sapling trays need to be stored and conveyed/transferred to the planting unit (which plants the saplings) in such a manner as not to affect the sapling quality and life. To fulfill such requirement the planting vehicle or the transplanter needs to have a sapling tray handling mechanism which can store the sapling trays in an optimum space and transfer the saplings to the picking area with precision and accuracy at the high operating speeds. Hence, there is felt a need for a new sapling tray handling system which obviates the problems of the currently available sapling tray handling systems.

The present disclosure envisages achieving at least one of the following objects including providing a sapling tray handling mechanism for a transplanter which can store the sapling trays in an optimum space and transfer the saplings to the picking area with precision and accuracy at the high operating speeds. Another object of the present disclosure is to optimize the number of parts. Yet another object of the present disclosure is to provide a drive system for the sapling handling system and the drive system comprises four linear actuators. Other objects of the present disclosure will be apparent when the description of the disclosure is read in conjunction with the accompanying drawings. The accompanying drawings provided herein are merely illustrative and do not intend to limit the scope and ambit of the present disclosure.

### SUMMARY OF THE DISCLOSURE

In accordance with the present disclosure, there is provided a sapling tray handling system for a transplanter. The sapling tray handling system comprises a track, a plurality of sapling trays, and a drive mechanism. The track has four corners and four sides forming a rectangular loop. The sapling trays are configured to traverse the track. The drive mechanism propels the sapling trays. Each corner is configured to secure one sapling tray. The drive mechanism comprises four actuators. Each actuator may be positioned at corners and is configured to propel the sapling tray secured at the respective corner.

A plurality of sapling trays are placed to occupy the entire track except one corner forming an empty corner. The actuators are actuated in a predetermined sequence to propel the plurality of sapling trays. A drive mechanism comprises a hydraulic power source and a main control valve to control the hydraulic fluid to the four actuators. The drive mechanism further comprises a controller, a plurality of sensors, a sequencing valve and a return manifold. The sequence includes detecting the fully extended position of each actuator and actuating a subsequent actuator in sequence. The drive actuators for the sapling handling system are linear actuators.

Various features, aspects and advantages of the present disclosure will be apparent from the following detailed description of the disclosure when read in conjunction with the accompanying drawings wherein like numerals represent like components.

The present disclosure has several technical advancements, including but not limited to the realization of less space consumption to carry large number of sapling trays and allows more space for serviceability or maintenance activity, optimal number of parts and low maintenance solution using stationary track and linear actuators, operation of tray handling system is simple and avoids any malfunction, pickup are and access area are same leading to easy loading of trays.

While the foregoing specification has been described with respect to at least one embodiment, the present disclosure can be further modified within the spirit and scope of this disclosure. This application is therefore intended to cover any variations, uses, or adaptations of the disclosure using its general principles. Further, this application is intended to cover such departures from the present disclosure which comes within known or customary practice in the art to which this disclosure pertains.

Other features and aspects will become apparent by consideration of the detailed description and accompanying drawings.

### BRIEF DESCRIPTION OF THE DRAWINGS

FIG. 1 illustrates a work machine with a transplanter coupled at a rear end;

FIG. 2 illustrates a perspective view of the sapling tray handling system attached to the transplanter frame;

FIG. 3 illustrates a sapling tray partially filled with saplings;

FIG. 4 illustrates the track along with a plurality of trays;

FIG. 5 illustrates the track along with a drive mechanism;

FIG. 6 illustrates a track corner with a base plate and an actuator in an extended position;

FIG. 7 illustrates the track corner with the actuator in a retracted position;

FIG. 8 illustrates an access area of the track with a gate in a closed position;

FIG. 9 illustrates an access area of the track with the gate in an open position;

FIGS. 10A-10D illustrate a sequence of the operation of the sapling tray handling system;

FIG. 11 illustrates a schematic view of the hydraulic circuit for drive mechanism; and

FIG. 12 illustrates a flow chart explaining the operation by a controller in handling trays.

Before any embodiments are explained in detail, it is to be understood that the disclosure is not limited in its application to the details of construction and the system of components set forth in the following description or illustrated in the following drawings. The disclosure is capable of other embodiments and of being practiced or of being carried out in various ways. Further embodiments of the disclosure may include any combination of features from one or more dependent claims, and such features may be incorporated, collectively or separately, into any independent claim.

### DETAILED DESCRIPTION

The embodiments disclosed in the above drawings and the following detailed description are not intended to be exhaustive or to limit the disclosure to these embodiments. Rather, there are several variations and modifications which may be made without departing from the scope of the present disclosure.

As used herein, the term “controller” is a computing device including a processor and a memory. The “controller” may be a single device or alternatively multiple devices.

As used herein, the term “module” refers to any hardware, software, firmware, electronic control component, processing logic, processing device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

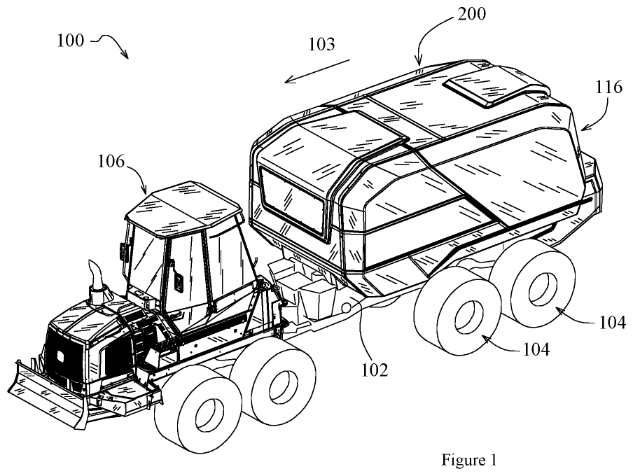

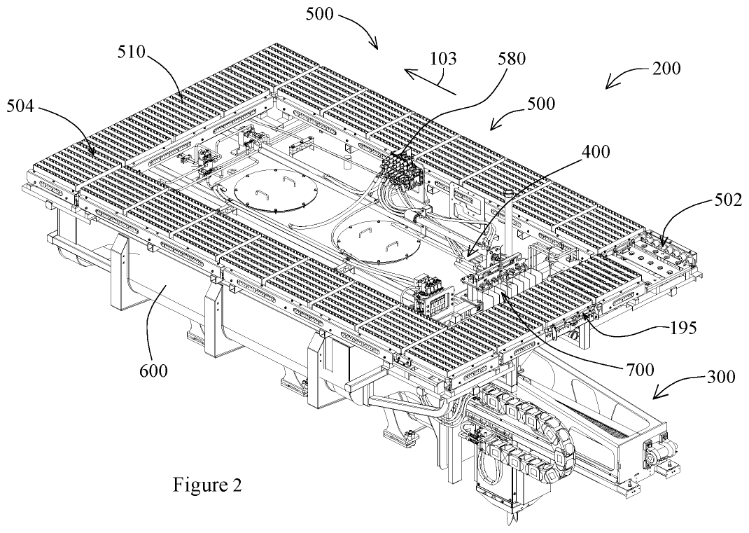

FIG. 1 illustrates a perspective view of a work machine 100 comprising a sapling transplanter 200. A sapling planting apparatus 300 (shown in FIG. 2) attached at rear end of the sapling transplanter 200, according to one embodiment. It is intended that the sapling planting apparatus 300 provides for continuous sapling planting while the work machine 100 continues to advance as the apparatus plants the sapling into the ground, thereby advantageously reducing fuel consumption and increasing efficiency by minimizing a stop/start of the work machine 100 when planting. An alternative embodiment may comprise a sapling transplanter 200 coupled to a work machine 100, such as a tractor, rather than a singular piece of equipment. Therein, the term work machine 100 may include a transplanter 200 on a work machine 100, or a work machine 100 towing a sapling transplanter 200. Note the sapling planting apparatus 300 is one of several subcomponents found within the planter vehicle. Furthermore, the terms “work machine,” “planter vehicle” and “transplanter” may be used interchangeably throughout this disclosure.

The planter vehicle or work machine 100 may comprise of one or more subcomponents and/or subsystems described herein to automate or semi-automate the sapling planting process. The present disclosure includes a planting vehicle or work machine 100 with multiple subsystems. However, used holistically or in part, these subsystems provide an improved process for planting multiple saplings through the automated or a semi-automated process. The work machine 100 may include a chassis 102, ground-engaging supports 104, such as wheels, and a propulsion system (not shown). The propulsion system, such as a diesel engine or motor, or an electric engine provides for motive power driving the wheels and for operating the other components associated with the planter vehicle or work machine 100 such as actuators. The operator cab 106, or alternatively a remote operating station (not shown) where an operator sits when operating the work machine 100, includes a user input interface with a plurality of controls (e.g. switches, joysticks, pedals, buttons, levers, display screens, etc.) for controlling the planter vehicle or work machine 100 during operation thereof.

As depicted in FIGS. 1 and 2, the forward portion or direction 103 of the planter vehicle or work machine 100 is generally to the left and the rearward portion or direction of the planter vehicle or work machine 100 is generally to the right. The planter vehicle or work machine 100 may include a sapling retrieval apparatus 400 (shown in the FIG. 2) which retrieves saplings from a sapling tray handling system 500 and feeds saplings into the sapling planting apparatus 300. The planter vehicle or work machine 100 may further include an external housing 116, which generally shields various subcomponents of the planter vehicle or work machine 100 from dust, debris, winds, rain, and other harsh environmental conditions. The primary subcomponents and subsystems may include the sapling tray handling system 500, the sapling retrieval apparatus 400, the sapling planting apparatus 300, and the sapling hydrating module 600 (which includes the water tank), a sapling transfer and indexing system 700 and a sensing module 190.

The controller 180 may have one or more microprocessor-based electronic control units or controllers which perform calculations and comparisons and execute instructions. The controller 180 may also include a processor, a core, volatile and non-volatile memory, digital and analog inputs, and digital and analog outputs. The controller 180 may connect to and communicate with various input and output devices including, but not limited to, switches, relays, solenoids, actuators, light emitting diodes (LED's), liquid crystal displays (LCD's) and other types of displays, radio frequency devices (RFD's), sensors, and other controllers. The controller 180 may receive communication or signals, via electrically or any suitable electromagnetic communication, from one or more devices, determine an appropriate response or action, and send communication or signals to one or more devices. The controller 180 can be a programmable logic controller, also known as a PLC or programmable controller. The controller 180 may couple to a separate work machine electronic control system through a data bus, such as a CAN bus, or the controller 180 can be a part of the work machine electronic control system.

The controller 180 may be in communication with one or more devices including, but not limited to, a vehicle speed sensor to receive information about the vehicle speed; position/proximity sensors to receive various positional inputs about the sapling stock as it moves through the planter vehicle or work machine 100; geolocation sensors to receive information about the planter vehicle's location; obstruction detector sensors; the pump and/or pump controller to provide commands or instructions and/or receive information about direction and flow of hydrating fluid to and from the hydrating fluid storage tank; visual inputs from cameras; and the user input interface to receive commands or instructions and provide feedback. The controller 180 may receive communication from and provide communications, controls, or instructions to any of these devices and any of the subcomponents. This list is not all-inclusive and is detailed further below.

The planting vehicle or work machine 100 may move across a field and retrieve one or more saplings 518 (e.g. a eucalyptus tree) from its sapling tray handling unit 500. The planting vehicle or work machine 100 may then plant a sapling 518 into the ground, while watering and or fertilizing the sapling 518. Note that the while the present embodiment demonstrates planting of a single sapling 518 at any given moment, the mechanism can be configured to plant two or more saplings at any given moment. The sapling tray handling system 500 comprises a rectangular loop track 502 to support a multitude of trays 504, the trays 504 collectively have the capacity to hold thousands of saplings 518. The sapling tray handling system 500 comprises a rectangular loop track thereby minimizing the footprint traversing the ground, while maximizing storage capacity of the sapling tray handling system 500 by transferring the plurality of trays within the track on the horizontal plane. A sapling hydrating module 600 is found below the rectangular track 502 to optimize usage of space. Furthermore, the smaller footprint allows for ease of transportation along industry standard roadways when transporting the planter vehicle or work machine 100 from a first location to a second location.

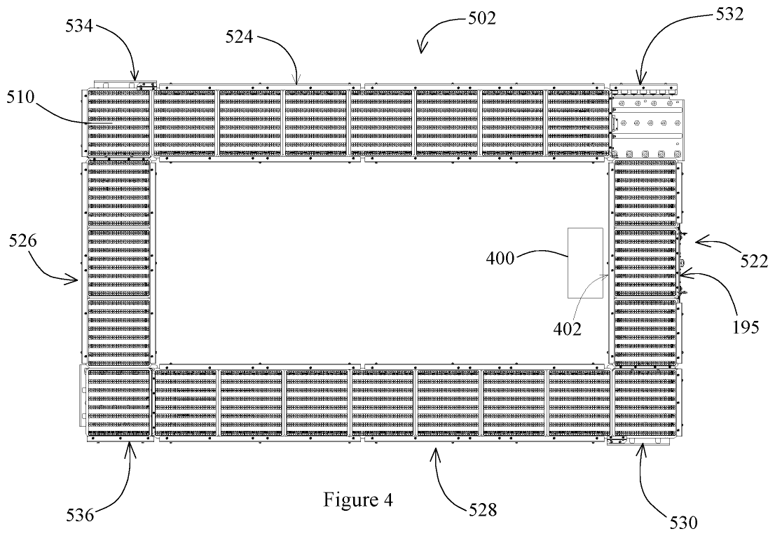

The saplings 518 are grouped in trays 510. The sapling tray handling system 500 is configured to convey the trays 510 holding rows of saplings 520 towards the sapling retrieval apparatus 400 (shown in FIGS. 2 and 4) and indexes to a next tray 510 as each tray is emptied by the sapling retrieval apparatus 400. Trays 510 are replaced by an operator in an access area 195, wherein the operator may reload the sapling tray handling system 500 with a new set of filled trays 510. The trays 510 are removably placed for sliding engagement on roller frames 538 in the track of the sapling tray handling system 500. In an embodiment as shown in FIG. 4 the access area 195 is the same as the pickup area 402 defined by the placement of the sapling retrieval apparatus 400. The pickup area 402 is where the sapling retrieval apparatus 400 may access the saplings 518. The controller 180 is programmed to control operation of the sapling tray handling system 500, wherein the controller 180 actuates a drive mechanism 580 upon receipt of input signals from various sensors which are part of a sensing module 190. The sensing module 190 may further comprises a plurality of tags including information distinguishing each individual sapling (e.g. an identification code), row of saplings, or tray of saplings from others may be attached to trays, wherein the controller 180 is programmed to record information from a tag reader and process the information as the sapling 518 is planted, thereby correlating the identification code with a geolocation of the sapling 518. This information may be aggregated in memory, thereby mapping productivity as it occurs. In one embodiment, the information can be visually displayed on a user input interface (not shown) as the planter vehicle or work machine 100 progresses, or after completion of a sapling lot.

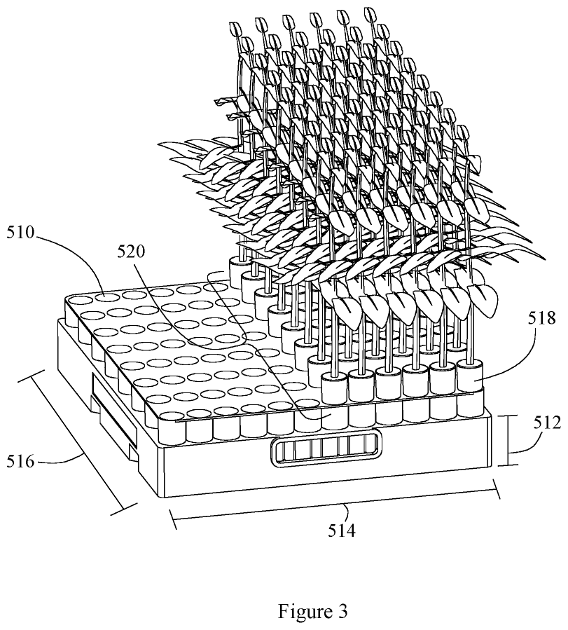

In an embodiment, as shown in FIG. 3 each sapling tray 510 may carry plurality of saplings 510 in multiple rows 520. Each tray preferably carries eight rows, and thirteen columns of saplings thus may accommodate one hundred and four saplings 518. The overall dimensions of the tray including width 516, length 514 and height 512 are optimized to fit into the track 502. In an embodiment, the width 516 and length 514 of the tray are approximately equal such that the tray 510 travers the track 502 efficiently. As shown in FIG. 4, the sapling tray handling system 500 may accommodate plurality of sapling trays 504 preferably twenty-three trays and thus may handle 2392 saplings. However, the above numbers are not limiting and may vary according to design and size of the transplanter 200.

As shown in FIGS. 2 and 4, the track 502 is fixed above the water tank of the hydrating module 600. The track 502 is formed in a rectangular loop form with four sides including a first side 522, a second side 524, a third side 526 and a fourth side 528. In alternative embodiments, the track 502 can be in a square or parallelogram or rhombus forms. Each of the two sides connect to form four corners including a first corner 532, a second corner 534, a third corner 536 and a fourth corner 530 respectively.

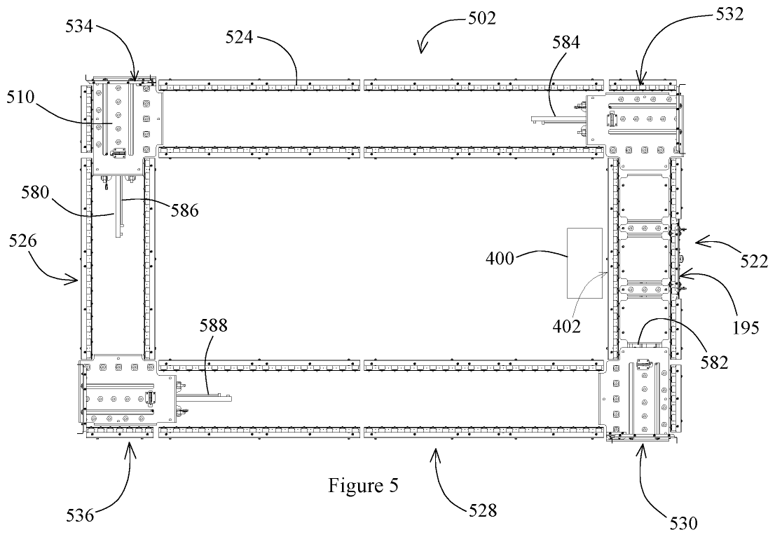

As shown in FIG. 5, the sapling tray handling system 500 further comprises of a drive mechanism 580 to propel the sapling trays 504. In an embodiment the drive mechanism 580 comprises of four actuators including a first actuator 582, a second actuator 584, a third actuator 580 and a fourth actuator 588 and each positioned at the first, second, third and fourth corners respectively of the track. In a further embodiment, the actuators are linear actuators and may be selected from but not limited to hydraulic actuators, electric actuators and pneumatic actuators. However, any other kind of actuators can be used to drive the sapling trays 510.

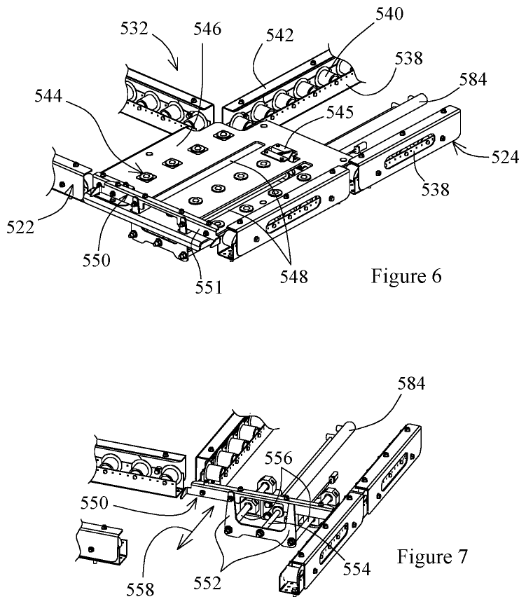

FIG. 6 shows the constructional features of the track and corner. The track 502 comprises a pair of roller frames 538 apart from each other. In an embodiment the roller frames are formed out of c columns and carry a plurality of rollers 540 rotatably connected to the roller frames 538. The roller frames 538 are placed at distance equivalent to the width 516 or the length 514 of the tray 510 such that sapling trays 510 slide over the rollers 540 without any hindrance. Each roller frame 538 further carries a side guard 542 on the outer side of the track 502. The side guard 542 is preferably in L shape and guides the trays 510 to avoid misalignment and vertical movement of the trays 510 along the track 502. As shown, the corner 532 is formed by intersecting two sides 524 & 522 of the track 502. Each corner further comprises a base plate 546 fixed to the roller frames 538. The base plate 546 carries a plurality of spherical ball transfer rollers 544 to support the tray 510 secured to the corner 532. The spherical ball transfer rollers 544 help the tray for a smooth transition from one side of the track 522 to the next side of the track 524.

FIGS. 6 and 7 show the arrangement of the actuator 584 at the corner 532 of the track 502. The linear actuator 584 is fixedly attached to the bottom side of the base plate 546. The linear actuator 584 is positioned parallel to the side of the track 524 such that the linear actuator 584 propels the trays 502 within the side of the track 524. The base plate 546 further comprises a pair of slots 548. These two slots 548 allow to transfer the movement from the actuators to the sapling tray 510 secured above the base plate. As shown in FIG. 7, the actuator 584 is attached to a fixed bracket and the actuator rod end extends beyond the fixed bracket. In an exemplary embodiment, the length of the rod 584 extension or retraction equals to the length/width of the sapling tray 510. A pusher bracket 550 is attached to the rod end 584 of the actuator 584. The pusher bracket 550 has an extending pair of fingers 552 and a push bar 551. The pair of fingers 552 passes through the pair of slots 548 and the push bar 551 is configured to catch the tray 510 and transfer the propel drive from the actuator 584 to the tray 510. A pair of sliding bars 556 are arranged on either side of the actuator 584 to have smooth operation of the actuator and avoid any unwanted load on the actuator 584. This construction of the corner 532 allows the actuator 584 and the tray 510 to be separated by the base plate 546 and still transfer the drive motion from actuator 584 to the trays 510. In an embodiment, the default position of the actuator 584 is in extended position (as shown in FIG. 6) and the push bar 550 is placed in alignment of the outer roller frame 538. This design helps in smooth movement of the tray into the corner 532 and away from the corner 532.

A lock 545 is provided on the base plate 546 to restrict the backward movement of the trays 510 in the side of the track 524. As shown in FIG. 4, while the corner 532 is unoccupied, the lock 545 restricts the movement of the trays 510 on side of the track 524 towards the corner 532. In an embodiment, the lock 545 is a gravity-based lock and by weight of the lock body the lock 545 is kept in a raised position by default to hold the tray movement in the direction 558. However, when a tray 510 from side 522 moves towards the corner 532, the bottom of the tray 510 pushes the lock 510 downward and the tray 510 itself hold the backward movement of the trays 510 from the side 524.

The remaining corners 584, 536 and 538 have a similar construction and operation while connecting sides 524 & 526, 526 & 528 and 528 and 522 sides of the track 502 respectively.

During operation of the sapling handling system 500, for each corner, when a tray 510 is secured in the corner and the controller 180 signals the actuator to propel the tray 510, the actuator which is in extended position as shown in FIG. 6 will shift to a retracted position as shown in FIG. 7. As the actuator retracts, the pusher bracket 550 holds and pushes the tray 510 along the track 524. As the tray 510 moves forward, it pushes the plurality of trays 510 ahead of it within the side of the track 524. As the tray 510 passes past the lock 545, as described earlier, the lock 545 raises to its active position and restrict the backward moment of the sapling tray 510. At this stage, the controller 180 signals the actuator 584 to move back to the default position. In an embodiment, it is contemplated that the system 500 comprises various sensing means to identify the position of the pusher bracket 550 and the trays 510 to avoid any unwanted failure of the system 500. The sensors are part of the sensing module 190 and could be selected from but not limited to position sensors, proximity sensors, hydraulic pressure sensors or in-piston position sensors. The working of the sensors will be described in later parts of this description.

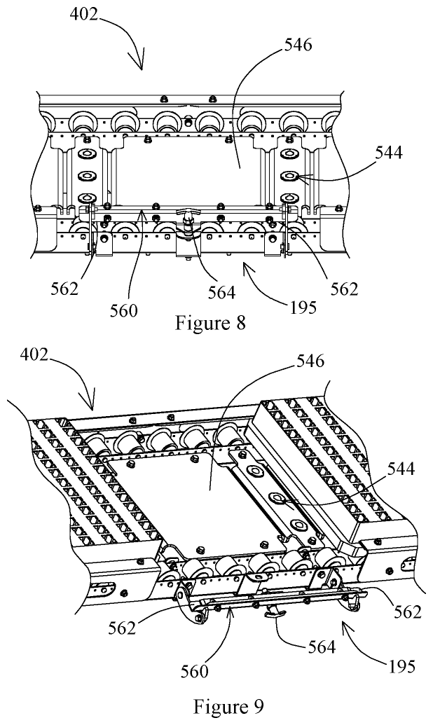

FIGS. 8 and 9 show tray access area 195. The access area 195 allows an operator to unload empty trays 510 and load trays 510 with saplings 518. A gate 560 is provided on the outer side roller frame 538. The gate 560 is pivotably attached and is configured to be in a closed state as shown in FIG. 8 and in an open state as shown in FIG. 9. In closed state, the gate 560 works like a roller frame and allow smooth movement of the sapling tray 510 and hold the tray when trays are not moving. The gate 560 has as latch 564 with a spring mechanism to keep gate 560 in closed position during normal operation. The access area 195 further has a base plate 546 to support the sapling tray 510 during the sapling pickup by sapling retrieval apparatus 400 and loading or unloading of trays 510. The base plate 546 further has roller bearings 544. During loading operation, the operator unlocks the latch 564 and opens the gate 560. Once the gate 560 is open, the operator may remove the trays 510 and/or add trays 510. In an embodiment, to assist the operator in loading the trays 510, the controller 180 may actuate the four actuators positioned at corners and move the trays 510 as the operator add or remove the trays 510 from the loading area 195. During loading operation, it is contemplated that the controller 180 may operate the actuators automatically by sensing the position of trays 510 or receive input from the operator to move the trays 510. In an additional embodiment, the operator may move the trays 510 manually during the unloading or loading of saplings trays 510.

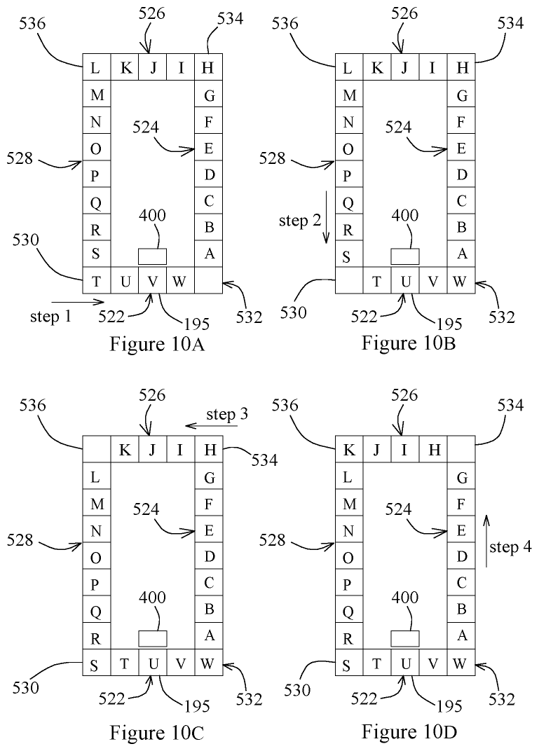

FIGS. 10A-10D schematically illustrate the working sequence of the tray drive mechanism 580 according to an embodiment. The sequence comprises four main steps to complete the cycle. As illustrated, the track 502 has capability to accommodate 24 sapling trays 510 (A-W). However, to allow movement of the 23 trays ‘A’ to ‘W’ are loaded and one corner 532 is kept empty. The sapling retrieval apparatus 400 picks the saplings 518 from the tray ‘V’ and when the tray ‘V’ gets empty, as STEP 1 the controller 180 actuates the actuator 582 at the corner 530 and propels the tray ‘T’ along the side 522. As the tray ‘T’ moves, it pushes the series of trays in the side 522 leaving the corner 530 empty. The tray ‘U’ now occupies the pickup area and tray ‘W’ occupies the corner 532. As STEP 2, the controller 180 actuates the actuator 588 at the corner 536 and propel the tray ‘L’ which further pushes the series of trays 510 occupied on side 528. The tray ‘S’ occupies the corner 530 and the corner 536 becomes empty. As STEP 3, the controller 180 actuates the actuator 586 at the corner 534 and propels the tray ‘H’ which further pushes the series of tray on side 526. The tray ‘K’ now occupies the corner 536 and corner 534 becomes empty. As STEP 4, the controller 180 actuates the actuator 584 at the corner 532 and propels the tray ‘W’ which further pushes the series of trays 510 on side 524. The tray ‘G’ now occupies the corner 534 and corner 532 becomes empty.

This sequence of Steps 1-4 allows the tray handling system 500 to transfer all trays 510 toward the sapling retrieval apparatus 400 one at a time until all trays 510 are empty. Then the operator will reload the trays 510 from the access area 195.

In the described sequence, the trays 510 are configured to move in an anti-clockwise direction within the track loop 502. However, a clockwise direction sequence may be achieved by keeping the corner 530 empty at initially and the actuator at corner 532 propels the secured tray 510 towards the corner 530 and the other three actuators drive in clockwise direction in a similar way.

The sequence described is for explanation purposes only and it is contemplated that by changing the position of initial empty corner and the direction of actuation a plurality of sequences may achieved and are covered under this disclosure. The controller 180 can be configured to achieve any of the sequences and the sequence may altered as per user/operator inputs to the controller 180 via display on the work machine 100 or from remote workstation.

In an embodiment, the predetermined sequence is stored in memory of the controller 180. It is contemplated that multiple sequences are stored in the memory. Operator may select any preferred sequence or may edit the sequence using the display on operator station. The controller 180 through the sensing module 190 may identify the full trays 510, empty trays 510 and partially filled trays 510 and is configured to operate a partial cycle until all trays 510 are empty or based on the operator input on when to stop the cycle.

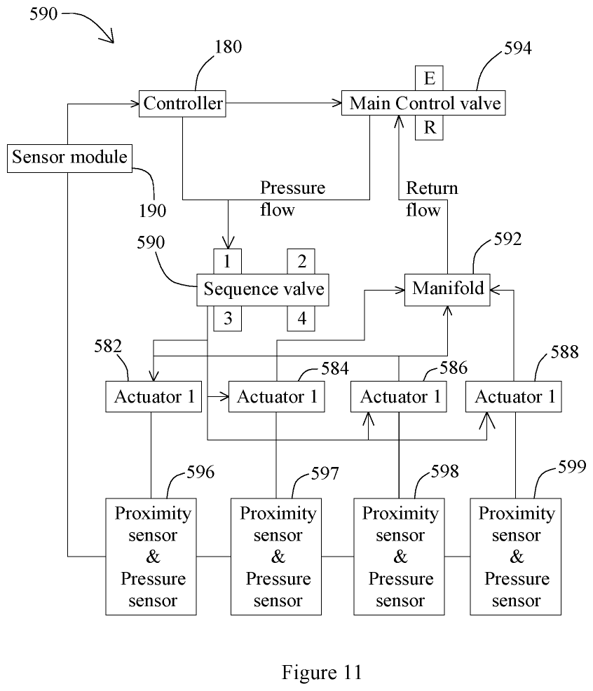

FIG. 11 illustrates a schematic hydraulic circuit for the drive mechanism 580. The main control valve 594 receives a hydraulic fluid power from a source (not shown). The controller 180 commands the main control valve 594 to supply hydraulic fluid to the sequencing valve 590. The controller 180 send instructions to sequencing valve 590 regarding which actuator to be actuated based on the pre-determined sequence. The sequencing valve 590 is hydraulically coupled to the four actuators 582-588 and the hydraulic fluid would be routed to the respective actuator as instructed by the controller 180. A single return manifold 592 is hydraulically coupled to the four actuators 582-588 and the return flow from each actuator is routed to the return manifold 592. The return manifold 592 returns the fluid to the main control valve 594. This circuit advantageously uses a single sequencing valve 590 and a single manifold valve 592 to operate the four actuators 582-588 independently and in sequence. As shown, a plurality of sensors 596-599 identify the position of each actuator respectively and the controller 180 based the sensor input proceed to next step.

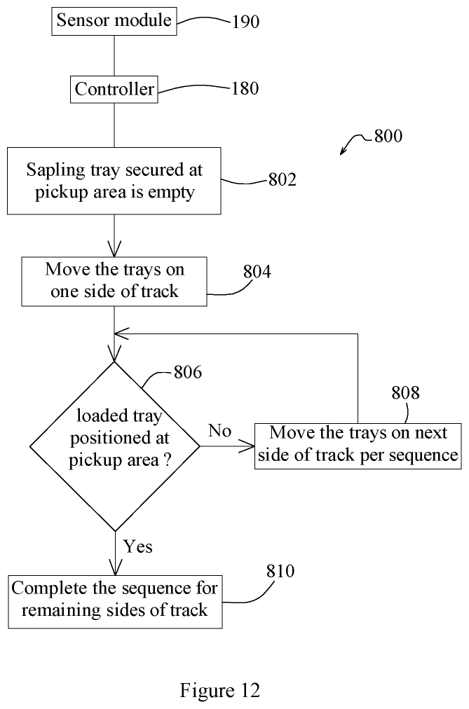

FIG. 12 illustrates a flow chart 800 showing how the controller 180 monitors the operation of the sapling tray handling system 500 to make sure a tray 510 with saplings 518 is always occupies the pickup area 402. At step 802, based on inputs form the sensing module 190, the controller 180 monitors picking of the saplings 518 by the sapling retrieving apparatus 400 and when the tray 510 becomes empty, at step 804 controller 180 actuates an actuator to move trays 510 on side of the track where the corner is empty. At step 806, controller 180 checks if a tray 510 with saplings 518 is loaded to the pickup area 402 and if yes, at step 810 the controller 180 completes the cycle by moving the rest of three actuators to move trays on rest of sides of the track. This enables to keep the empty corner at initial position after a complete cycle. If at step 806, controller 180 decides that a tray 510 with saplings 518 is not loaded at the pickup area 402, controller 180 moves the trays 510 in second side within predetermined sequence and continue the sequence until a tray 510 with saplings 518 occupies the pickup area 402. Once the sequence is complete, the controller 180 locks the actuators to avoid any unwanted the movement of the trays 510.

Various features are set forth in the following claims.

What is claimed is:

1. A sapling tray handling system for a transplanter comprising:
a track, a plurality of sapling trays, and a drive mechanism, wherein the track has four corners and four sides;
the sapling trays are configured to traverse the track and the drive mechanism propels the sapling trays from a first side to a second side of the track;
each corner of the four corners is configured to secure one sapling tray;
the drive mechanism comprises four actuators with each actuator positioned at one of the four corners and is configured to propel the sapling tray secured at the respective corner.

2. The sapling tray handling system of claim 1, wherein the plurality of sapling trays occupy the track except one corner forming an empty corner.

3. The sapling tray handling system of claim 2, wherein each actuator propels the plurality of sapling trays occupying the side of the track towards the empty corner.

4. The sapling tray handling system of claim 1, wherein the four actuators are actuated in a predetermined sequence to propel the plurality of sapling trays.

5. The sapling tray handling system of claim 4, wherein the predetermined sequence includes propelling the plurality of sapling trays in a clockwise or a counterclockwise direction.

6. The sapling tray handling system of claim 1, wherein a sapling retrieval apparatus is positioned adjacent the track and the sapling retrieval apparatus is configured to pick the saplings.

7. The sapling tray handling system of claim 1, wherein the track comprises a locking means to restrict the movement of the plurality of sapling trays.

8. The sapling tray handling system of claim 1, wherein the plurality of sapling trays comprise a matrix of slots to carry saplings.

9. The sapling tray handling system of claim 1, wherein each side of the track comprises a pair of roller frames to carry the plurality of sapling trays and a side guard configured to guide the tray movement.

10. The sapling tray handling system of claim 1, wherein the actuator comprises a pusher bracket to engage and propel the sapling tray secured to the corner.

11. The sapling tray handling system of claim 1, wherein the corner comprises a base plate to secure the sapling tray and the actuator.

12. The sapling tray handling system of claim 11, wherein the base plate further comprises a plurality of spherical ball transfer rollers allowing the sapling tray transition from one side to another side of the track.

13. The sampling tray handling system of claim 11, wherein the sapling tray and the actuator are secured on opposite sides of the base plate.

14. The sapling tray handling system of claim 1, wherein the drive mechanism further comprises a hydraulic power source and a main control valve to control the hydraulic fluid to the actuators.

15. The sapling tray handling system of claim 14, wherein the drive mechanism further comprises a sequencing valve to control the actuators in the predetermined sequence.

16. The sapling tray handling system of claim 14, wherein the drive mechanism further comprises a controller, a plurality of sensors to detect the position of actuators including a fully extended position and a fully retracted position and the controller is configured to control the main control valve and the sequencing valve based on the output from the plurality of sensors.

17. The sapling tray handling system of claim 14, wherein the predetermined sequence includes detecting the fully extended position of the actuator and retracting a subsequent actuator in sequence.

18. The sapling tray handling system of claim 16, wherein the default position for the actuator is the fully extended position and the controller actuates the actuators to the fully retracted position propelling the sapling trays secured in the respective corner.

19. The sapling tray handling system of claim 16, wherein the plurality of sensors include proximity sensors and pressure sensors.

20. The sapling tray handling system of claim 1, wherein the actuators are linear actuators.
